(19) United States
(12) Patent Application Publication
(10) Pub. No.: US 2014/0129009 A1
(43) Pub. Date: May 8, 2014

(54) SYSTEM FOR FANTASY SPORTS SCORING

(71) Applicant: Eric Mager, New York, NY (US)

(72) Inventor: Eric Mager, New York, NY (US)

(21) Appl. No.: 13/672,525

(22) Filed: Nov. 8, 2012

(51) Int. Cl. G06F 17/00

(52) U.S. Cl. CPC G06F 17/00
USPC 700/92

(57) ABSTRACT

A scoring mechanism for a fantasy league where a user may choose a score setting of at least one from a group that includes a weekly scoring system based on head to head match up and a seasonal scoring system based on total acquired points. The user of the league may choose to give each scoring mechanism an equal weight which may be a default setup or may personalize the weights for each mechanism. The user of the league may also decide whether or not to have playoffs.

### BACKGROUND OF THE INVENTION

The present invention relates to fantasy scoring for fantasy leagues based on the actual performance of professional athletes.

Currently, fantasy leagues are scored using various scoring mechanisms. Some leagues use head to head points or head to head category systems where a team has a weekly one on one match-up against another team in the league and whoever has the most points wins the week. This method of scoring increases competition, is easy to understand and can facilitate playoffs. However, this type of scoring is volatile and a team might have the second best overall score in the league but still lose to an opponent whose team had a better score.

Another fantasy league scoring mechanism is known as Rotisserie. In a Rotisserie league, a team will compete in categories throughout the entire season against all other teams in the league. This method of scoring is very strategic and typically the best team in that league wins. However, the drawback of a Rotisserie league is that it may be less entertaining because the competition does not include head to head competition or playoffs.

As can be seen, there is a need for a scoring mechanism for a fantasy league that incorporates the best elements of a head to head points league, a head to head categories league, and a rotisserie league.

### SUMMARY OF THE INVENTION

In one aspect of the present invention a system for scoring fantasy sports, comprising: a computer having a user interface; and a program product comprising machine-readable program code for causing, when executed, the computer to perform the following process steps: producing an electronic representation of a fantasy sports league comprising a plurality of fantasy teams each comprising at least one fantasy player corresponding to a real life player; prompting a user to set settings for the fantasy sports league via the user interface; prompting a user to set a scoring format for the fantasy sports league comprising at least one of a weekly scoring system based on head to head match up and a seasonal scoring system based on total acquired points; receiving the scoring format from the user; and rewarding a second user based at least in part on the scoring format.

In another aspect of the present invention, the at least one of a weekly scoring system based on head to head match up and a seasonal scoring system based on total acquired points comprises at least one of a head to head point value system, a head to head category system, and a rotisserie point value system.

In another aspect of the present invention, the program product further causes the machine to prompt said user to set a weight for each scoring format.

In another aspect of the present invention, the weight is a percentage assigned to each scoring format.

In another aspect of the present invention, the program product further causes the machine to prompt the user to select a playoffs within the settings.

In another aspect of the present invention, the program product further causes the machine to calculate a total points available for the head to head point value system, the head to head category system, and the rotisserie point value system.

In another aspect of the present invention, the total points available for the head to head category system is calculated using the following formula: [(number of teams*number of categories*number of weeks played)/2]; wherein the total points available for the head to head point value system is calculated using the following formula: [(number of weeks*number of teams)/2]; and wherein the total points available for the Rotisserie system is calculated using the following formula: [(number of teams*(number of teams+1)/2)* number of categories].

In another aspect of the present invention, the program product further causes the machine to calculate a share, wherein the share is a percentage of the total points available that has been awarded to each individual fantasy team.

In another aspect of the present invention, the program product further causes the machine to rank the plurality of fantasy teams by the following formula:

(Head to Head Categories share *Head to Head Categories weight)+(Head to Head Points share*Head to Head Points weight)+(Rotisserie share*Rotisserie weight).

These and other features, aspects and advantages of the present invention will become better understood with reference to the following drawings, description and claims.

### BRIEF DESCRIPTION OF THE DRAWINGS

FIG. 1 is a flowchart of the league schematic;

FIG. 2 is a flowchart of the user's role; and

FIG. 3 is a flowchart of the scoring system schematic for head-to-head points and categories.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a scoring mechanism for a fantasy league where a user may choose a score setting of at least one from a group that includes a weekly scoring system based on head to head match up and a seasonal scoring system based on total acquired points. The user of the league may choose to give each scoring mechanism an equal weight which may be a default setup or may personalize the weights for each mechanism. The user of the league may also decide whether or not to have playoffs.

The system for playing fantasy sports may include at least one computer with a user interface. The computer may include any computer including, but not limited to, a desktop, laptop, and smart device, such as, a tablet and smart phone. The computer includes a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

The steps that are performed by the program product may include, but are not limited to: producing an electronic representation of a fantasy sports league comprising a plurality of fantasy teams, each comprising of at least one fantasy player corresponding to a real life player; prompting a user to set settings for the fantasy sports league via the user interface; prompting a user to set a scoring format for the fantasy sports league comprising at least one system selected from the group consisting of a weekly scoring system based on head to head match up and a seasonal scoring system based on total acquired points; and receiving the scoring format from the user.

In certain embodiments of the invention, the weekly scoring system based on head to head match up may be a head to head point value system or a head to head category system. The head to head point value system includes at least two fantasy teams facing off each week. The fantasy teams acquire points based on the performance of the individual fantasy players on the fantasy team. The fantasy team with the most points awarded wins the week. The fantasy team that wins tallies a win for the week and the fantasy team that loses tallies a loss for the week. The tallied wins and losses are used in the weekly scoring system. The head to head category system includes at least two fantasy teams facing off each week. The fantasy teams acquire categories, which equates to points. The team with the most categories wins that individual week. The fantasy team that wins tallies a win for the week and the fantasy team that loses tallies a loss for the week. The tallied wins and losses are used in the weekly scoring system.

In certain embodiments of the invention, the seasonal scoring system based on total acquired points may include a head to head point value system or a Rotisserie system. In the head to head point value system, the total number of points for each week awarded to each fantasy team is added up to a total score. The total score throughout the season for each fantasy team is counted. Head to head category system and Rotisserie system counts the amount of points or categories for the year. In particular, a Rotisserie system may count the total number of categories for each fantasy team every week, ranking every fantasy team in the fantasy league together. The fantasy team with the most points is the leader.

The program product may further cause the machine to prompt the user to set a weight for each scoring format. The weight is a percentage of categories and/or points accumulated for each scoring format. The user may select a particular percentage for each scoring format. For example, the rotisserie value may be between 0% and about 100%, the head to head point value may be between 0% and about 100% and the head to head category value may be between 0% and about 100%. However, in certain embodiments, the program product may provide a default setting in which each scoring format is awarded an equal weight. All of the selected weights of each type of scoring may add up to 100%.

For each scoring format, the program product that implements the fantasy league may distribute a total amount of points, such as points or categories, to the fantasy teams. The total amount of points may be calculated for each scoring format. In such embodiments, the program product may implement an algorithm. The algorithm may calculate the total points available for each type of scoring format. For example, every scoring format may provide a total amount of points or categories allotted based on how many categories selected, how many weeks are played, how many fantasy teams are within the fantasy league, and the like.

For head to head categories, there may be a total number of available regular season points equal to [(number of teams*number of categories*number of weeks played)/2]. For head to head points, there may be a total number of available regular season points equal to [(number of weeks*number of teams)/2]. For Rotisserie, there may be a set number of total regular season points available equal to [(number of teams*(number of teams+1)/2)* number of categories].

Every fantasy team, at any point in the season, may be awarded a percentage of the total points available. The percentage of the total available points awarded to each team may be considered the share for each scoring format. For example, the head to head categories scoring format may have a head to head categories share, the head to head points scoring format may have a head to head points share, and the Rotisserie scoring format may have a Rotisserie share.

The share that each team has may be used in conjunction with the weight percentage set by the user in the settings. For example, multiplying the share by the weight percentage for each scoring format may provide a weighted rank. The weighted rank of each scoring format may be added to the weighted rank of other selected scoring formats to provide a total rank for the fantasy team.

The total rank of each fantasy team may be ranked against other fantasy teams to provide the ranking system of the fantasy league.

In an exemplary embodiment of the invention, ranking the fantasy teams may use the following formula:

(Head to Head Categories share*Head to Head Categories weight)+(Head to Head Points share*Head to Head Points weight)+(Rotisserie share*Rotisserie weight).

In certain embodiments, the total rank of each fantasy team may be used for the playoffs settings. For example, teams with the highest total rank may be selected to play in the playoffs. The teams with the lowest total rank may not be selected to play in the playoff or may be selected to play in a consolation round of the playoffs. In certain embodiments, the accumulation of points and categories may be awarded in the playoffs by the method and system described above.

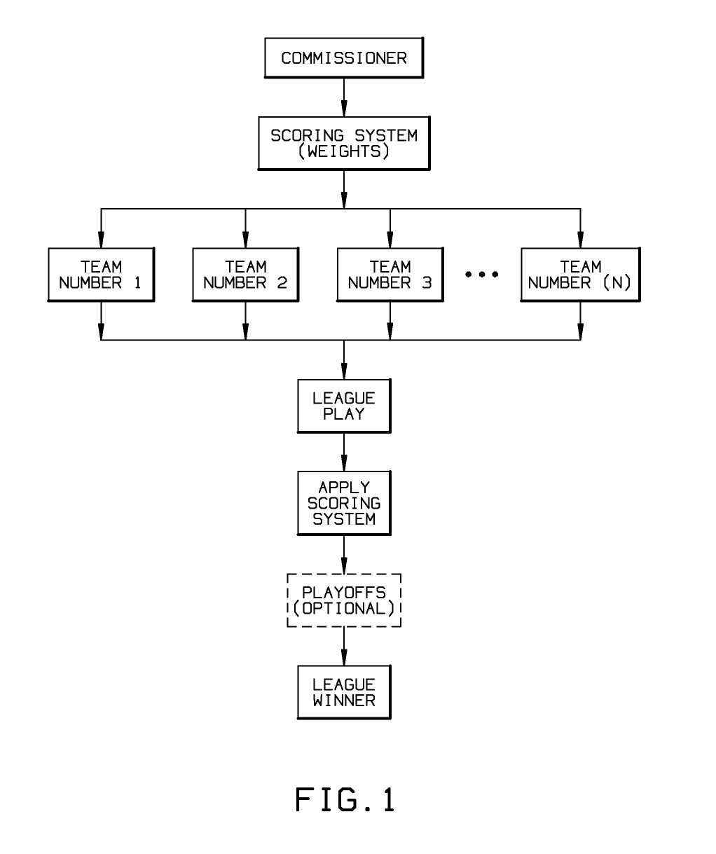

Referring to FIG. 1, a flowchart of an exemplary embodiment of the invention for scoring a fantasy league is illustrated. The user picks a scoring system and assigns weights to the scoring system. The league has multiple teams whose ranks' are determined through league play and the applied scoring system. The winner of the league will be the team with the best score after the end of the season unless the user chooses to have a playoff. In the event of playoffs, the league winner is the victor who emerges from the playoff competition.

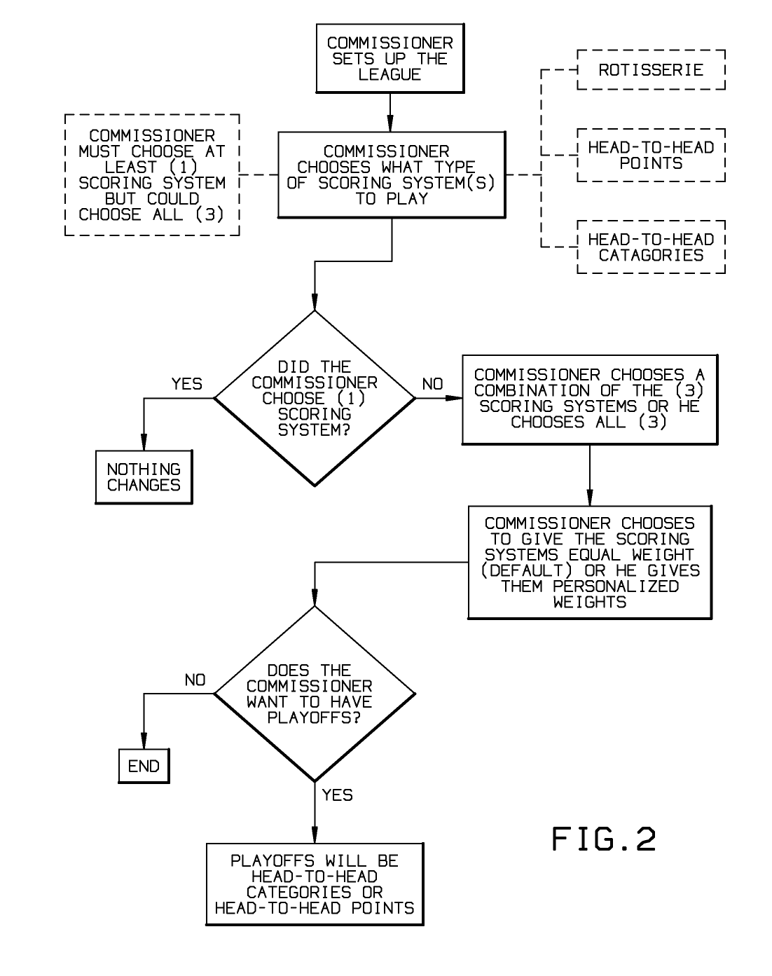

Referring to FIG. 2, a flowchart of an exemplary embodiment of the invention is illustrated, outlining the user's role. The user sets up the fantasy league and chooses what type of scoring system may be applied to the league. In certain embodiments, the user may choose between Rotisserie, head to head points, and head to head categories and the user picks at least one of the scoring systems.

If the user chooses more than one scoring system for the fantasy league, then the user may select the weights that are applied to each scoring system. However, in certain embodiments, the weights may be equal between all of the scoring systems.

The user may also select whether the fantasy league has playoffs. If the fantasy league has playoffs, the winner of the league may be determined by the playoff competition. If the fantasy league does not have playoffs the winner of the league may be the team ranked as number 1 after the regular season.

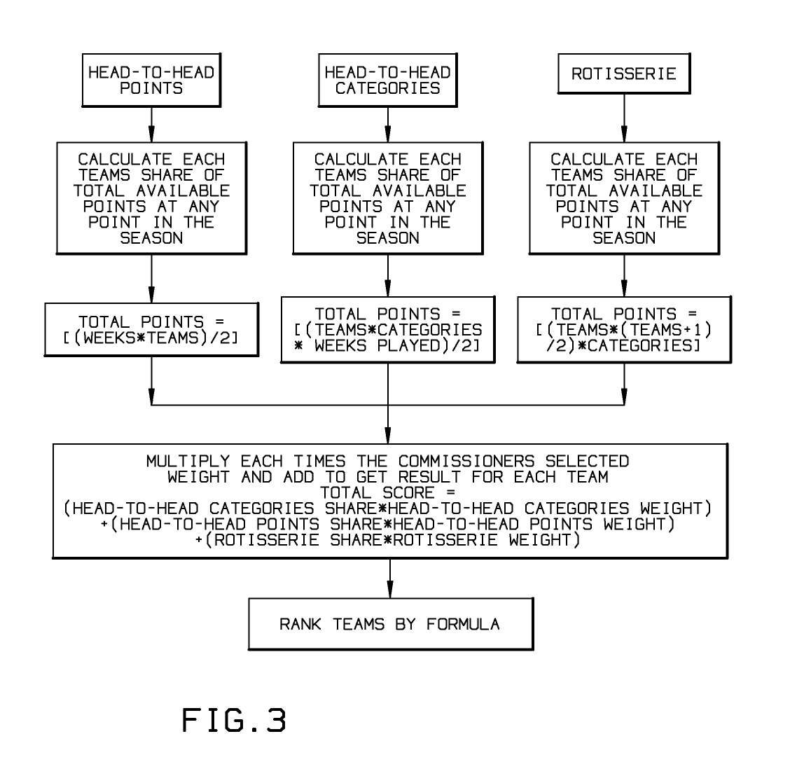

Referring to FIG. 3, a flowchart of an exemplary embodiment of the invention is illustrated, outlining the scoring system schematic for head-to head points and categories.

In a head to head points fantasy league, each team's share of total available points at any point in the season is calculated. The total head to head points allotted is calculated where the total points=[(number of weeks*number of teams)/2].

In a head to head categories fantasy league, each team's share of total available points at any point in the season is calculated. The total head to head categories is calculated where the total points=[(number of teams*number of categories*number of weeks played)/2].

In a Rotisserie fantasy league, each team's share of total available points at any point in the season is calculated. The total Rotisserie points or categories is calculated where the total points=[(number of teams* (number of teams+1)12)* number of categories].

A percentage of the scoring formula that calculates the total available points may be determined for each team, which may further be multiplied by the weight to get a final score for each team. The final Score =[Head to Head Categories Score*Head to Head Categories Weight]+[Head to Head Points Score*Head to Head Points Weight]+[Rotisserie Score*Rotisserie Weight]. Once the total score is tabulated, the teams are ranked accordingly.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A system for scoring fantasy sports, comprising:
a computer having a user interface; and
a program product comprising machine-readable program code for causing, when executed, the computer to perform the following process steps:
producing an electronic representation of a fantasy sports league comprising a plurality of fantasy teams each comprising at least one fantasy player corresponding to a real life player;
prompting a user to set settings for the fantasy sports league via the user interface;
prompting a user to select at least two-a scoring formats for the fantasy sports league, wherein the scoring formats comprise a head to head point value system, a head to head category system, a seasonal point scoring system, and a rotisserie system, wherein each of the scoring formats selected comprises a weight relative to the other scoring formats;
receiving the scoring formats selected by the user; and
rewarding a second user based at least in part on the scoring format.

2. (canceled)

3. The system of claim 1, wherein the program product further causes the computer to prompt said user to set the weight for each of the scoring formats selected.

4. The system of claim 1, wherein the weight is a percentage assigned to each scoring format.

5. The system of claim 1, wherein the program product further causes the computer to prompt the user to select a playoffs within the settings.

6. The system of claim 1, wherein the program product further causes the computer to calculate a total points available for the head to head point value system, the head to head category system, the seasonal point scoring system, and the rotisserie system.

7. The system of claim 6, wherein the total points available for the head to head category system is calculated using the following formula:
[(number of teams*number of categories*number of weeks played)/2];
wherein the total points available for the head to head point value system is calculated using the following formula:
[(number of weeks*number of teams)/2]; and
wherein the total points available for the Rotisserie system is calculated using the following formula:
[(number of teams*(number of teams+1)/2)* number of categories].

8. The system of claim 7, wherein the program product further causes the computer to calculate a share, wherein the share is a percentage of the total points available that has been awarded to each individual fantasy team.

9. The system of claim 8, wherein the program product further causes the computer to rank the plurality of fantasy teams by the following formula:
(Head to Head Categories share *Head to Head Categories weight)+(Head to Head Points share*Head to Head Points weight)+(Rotisserie share*Rotisserie weight).
